(19) United States
(12) Patent Application Publication
(10) Pub. No.: US 2026/0319280 A1
(43) Pub. Date: Oct. 15, 2026

(54) Low-power and Low-loss Optical Phase Shifter

(71) Applicant: IMEC VZW, Leuven (BE)

(72) Inventors: Qingzhong Deng, Oud-Heverlee (BE); Joris Van Campenhout, Leuven (BE); Chiara Marchese, Woluwe-Saint-Lambert (BE); Christian Haffner, Heverlee (BE); Filippo Jacopo Ferraro, Etterbeek (BE); Peter Verheyen, Nijlen (BE)

(21) Appl. No.: 19/643,215

(22) Filed: Apr. 9, 2026

(30) Foreign Application Priority Data
Apr. 11, 2025 (EP) 25169971.6

(51) Int. Cl. G02F 1/025

(52) U.S. Cl. CPC G02F 1/025

(57) ABSTRACT

The disclosure relates to an integrated optical structure. The integrated optical structure comprises an optical waveguide structure and a beam structure suspended at a first distance from the optical waveguide structure. The beam structure includes a first section of a first material and a second section of a second material. The first material is a conductive material and the second material is a non-conductive material or a semiconductor. The optical structure also includes an electrode structure arranged at a second distance to the beam structure and an electrical contact structure configured to apply a voltage between the electrode structure and the first section of the beam structure. The beam structure is designed to be elastically bent towards or away from the optical waveguide structure by the electrostatic force causing a change in an optical property of an optical signal propagating through the optical waveguide structure.

### CROSS-REFERENCE TO RELATED APPLICATIONS

The present application is a non-provisional patent application claiming priority to European Patent EP 25169971.6, filed Apr. 11, 2025, the contents of which are hereby incorporated by reference.

### FIELD OF THE DISCLOSURE

The present disclosure relates to light modulation in optical interconnects. More specifically, the present disclosure relates to an integrated optical structure for light modulation and to a method of fabricating such an integrated optical structure.

### BACKGROUND

Optical interconnects are systems for propagating optical signals within an integrated circuit. Such optical interconnects may involve efficient and compact optical modulators for modulating optical properties of a propagating light beam, e.g. its amplitude, polarization, or phase. Silicon (Si) carrier-based modulators with p-n junctions may be used for optical interconnects in integrated circuits. While p-n junction based modulators may be relatively fast, they may have only weak phase modulations.

Furthermore, resonance-based devices, such as Si ring modulators, may be prone to fabrication and thermally induced variations of their operating wavelengths. These variations may be controlled by phase tuning elements. This may be done with thermo-optic phase tuners, which may use local heaters. Metallic heaters for thermo-optic phase turning may allow for relatively large phase changes, which may be due to large changes in refractive index caused by temperature changes, e.g., Δn_{eff} ~ 10⁻²), but may be relatively slow (e.g., few kHz to MHz) and may suffer from a high power consumption (e.g., several milliwatts (mW)).

### SUMMARY

In view of the above, the present disclosure provides an optical structure and a method of fabricating an optical structure, which may avoid the above-mentioned disadvantages. The present disclosure provides an integrated optical structure for light modulation, which may offer fast modulation speed and low power consumption.

According to a first aspect, the present disclosure relates to an integrated optical structure. The integrated optical structure comprises an optical waveguide structure; a beam structure which is suspended at a first distance to the optical waveguide structure, wherein the beam structure comprises a first section of a first material and a second section of a second material, wherein the first material is a conductive material and the second material is a non-conductive material or a semiconductor; an electrode structure arranged at a second distance to the beam structure; and an electrical contact structure configured to apply a voltage between the electrode structure and the first section of the beam structure inducing an electrostatic force acting between the electrode structure and the first section; wherein the beam structure is designed to be elastically bent towards or away from the optical waveguide structure by the electrostatic force causing a change in an optical property, in particular a phase, of an optical signal propagating through the optical waveguide structure.

An optical modulator, e.g., a phase shifter, may have a relatively fast modulation of the optical signal and a low power consumption. In particular, the integrated optical structure described above may involve less power and may offer faster speeds than a other thermo-optic phase tuners. The integrated optical structure may involve zero or very low static power and may offer megahertz (MHz) to sub-gigahertz (GHz) speeds. At the same time, the integrated optical structure may enable phase shifting with very low optical losses.

The integrated optical structure may form an optical modulator, in particular a phase tuner. The phase tuner may be a nano-electro-opto-mechanical (NOEM) phase tuner.

When bending the beam structure towards or away the optical waveguide structure, the reduction or increase respectively of the distance between the waveguide structure and the beam structure may change an effective refractive index (n_{eff}) or more specifically a mode index as experienced by the optical signal propagating through the waveguide structure. This in-turn may cause a change in the optical parameter (e.g., phase) of the optical signal.

Besides the phase, other parameters of the optical signal, such as amplitude or polarization, may be influenced and/or changed by the change in distance between the waveguide structure and the beam structure.

The beam structure may be designed to have an elastic modulus that may allow it to be bent by the electrostatic force by such a degree that a tangible change of the optical property of the optical signal may occur.

The electrical contact structure may include a number of metallic contacts and electrical lines, which may connect to the electrode structure and the beam structure, in particular the first section of the beam structure. The electrical contact structure may be connected to a voltage source for generating the voltage. The voltage source may be an external voltage source or can be a component of the optical structure.

The optical waveguide structure (in the following sometimes referred to as: “waveguide structure”) may comprise or may form an optical waveguide, wherein the optical signal may propagate through the optical waveguide.

The optical waveguide structure may be made of silicon.

The beam structure may be arranged in a parallel orientation to the optical waveguide structure. The beam structure may be suspended at the distance above or below the optical waveguide structure.

The components of the integrated optical structure may be fabricated onto a single substrate material (e.g., a silicon substrate). This “integration” of the components in a single substrate may allow for a compact structure, which may be efficiently fabricated using semiconductor processing technologies (e.g., layer deposition and etching techniques).

In an embodiment, the optical waveguide structure may not be in physical contact with the electrode structure.

In an embodiment, the beam structure may be suspended on one end. In an embodiment, the first section may be arranged towards the suspended end and/or the second section may be arranged towards a free end of the beam structure. Doing so may facilitate the beam structure efficiently bending towards or away from the electrode structure.

The beam structure may be a cantilever structure. Alternatively, the beam structure may be suspended on two opposite ends.

In an embodiment, the second section may be arranged directly above or below the optical waveguide structure when the beam structure is not bent.

The first and second sections may be arranged on the beam structure in such a manner that the second section is closer to the waveguide structure than the first section both in the bent and non-bent state of the beam structure.

In an embodiment, the first material may be a metal or doped semiconductor, e.g., doped silicon.

In an embodiment, the second material may be silicon oxide or silicon nitride. The second material may be a low-loss optical material. This may facilitate a reduction in optical losses due to the proximity of the bent beam structure to the waveguide structure.

In an embodiment, the beam structure may include a base structure. In an embodiment, the first section and/or the second section may be embedded in the base structure.

In an embodiment, the base structure may be made of the same material as the second section. This may facilitate the beam structure being easy to fabricate and/or that optical losses being further reduced.

In an embodiment, the integrated optical structure may include a supporting structure. In an embodiment, the beam structure may be anchored to the supporting structure. In an embodiment, the optical waveguide structure and/or the electrode structure may be arranged in or on the supporting structure.

The supporting structure may be a part of an encapsulation structure that surrounds the beam structure on at least three sides.

In an embodiment, the electrode structure may be arranged at the same side of the beam structure as the optical waveguide structure, or the electrode structure and the optical waveguide structure may be arranged on opposite sides of the beam structure.

In an embodiment, the integrated optical structure may include a further electrode structure arranged at a third distance to the beam structure on a side which is opposite to the electrode structure.

In an embodiment, the electrical contact structure may be configured to apply a further voltage between the further electrode structure and the first section of the beam structure inducing a further electrostatic force acting between the further electrode and the first section. In an embodiment, the beam structure may be designed to be elastically bent towards or away from the further electrode structure by the further electrostatic force.

In an embodiment, the optical waveguide structure may be arranged in a closed loop forming a ring or disk waveguide.

According to a second aspect, the present disclosure relates to an optical communication device comprising the integrated optical structure of the first aspect of the present disclosure.

In an embodiment, the optical communication device may be a Mach-Zehnder interferometer or an optical resonator, e.g., a ring resonator.

According to a third aspect, the present disclosure relates to a method of fabricating an integrated optical structure. The method comprises: forming an optical waveguide structure; forming a beam structure which is suspended at a first distance to the optical waveguide structure, wherein the beam structure comprises a first section of a first material and a second section of a second material, wherein the first material is a conductive material and the second material is a non-conductive material or a semiconductor; forming an electrode structure arranged at a second distance to the beam structure; and forming an electrical contact structure which is configured to apply a voltage between the electrode structure and the first section of the beam structure inducing an electrostatic force acting between the electrode structure and the first section; wherein the beam structure is designed to be elastically bent towards or away from the optical waveguide structure by the electrostatic force causing a change in an optical property, in particular a phase, of an optical signal propagating through the optical waveguide structure.

In an embodiment, the beam structure may be formed in a parallel orientation to the optical waveguide structure. In an embodiment, a sacrificial structure may be formed around a section of the beam structure. In an embodiment, at least a part of the sacrificial structure may be arranged between the beam structure and the optical waveguide structure.

In an embodiment, the method may further include forming an encapsulation structure around the optical waveguide structure, the beam structure and the sacrificial structure. In an embodiment, the method may also include selectively removing the sacrificial structure to generate a cavity in the encapsulation structure. In some embodiments, the beam structure may be suspended in the cavity.

In an embodiment, the optical waveguide structure may not be in physical contact with the electrode structure.

In an embodiment, the beam structure may be suspended on one end. In an embodiment, the first section may be arranged towards the suspended end and/or the second section may be arranged towards a free end of the beam structure.

In an embodiment, the second section may be arranged directly above or below the optical waveguide structure when the beam structure is not bent.

In an embodiment, the first material may be a metal or doped semiconductor, e.g., doped silicon.

In an embodiment, the second material may be silicon oxide or silicon nitride.

In an embodiment, the beam structure may include a base structure. In an embodiment, the first section and/or the second section may be embedded in the base structure.

In an embodiment, the base structure may be made of the same material as the second section.

In an embodiment, the method may include forming a supporting structure. In an embodiment, the beam structure may be anchored to the supporting structure. In an embodiment, the optical waveguide structure and/or the electrode structure may be arranged in or on the supporting structure.

In an embodiment, the electrode structure may be arranged at the same side of the beam structure as the optical waveguide structure, or the electrode structure and the optical waveguide structure may be arranged on opposite sides of the beam structure.

In an embodiment, the method may include forming a further electrode structure arranged at a third distance to the beam structure on a side which is opposite to the electrode structure.

In an embodiment, the electrical contact structure may be configured to apply a further voltage between the further electrode structure and the first section of the beam structure inducing a further electrostatic force acting between the further electrode and the first section. In an embodiment, the beam structure may be designed to be elastically bent towards or away from the further electrode structure by the further electrostatic force.

In an embodiment, the method according to the third aspect of the disclosure may be used to fabricate the integrated optical structure according to the first aspect of the disclosure.

### BRIEF DESCRIPTION OF THE FIGURES

The above, as well as additional, features will be better understood through the following illustrative and non-limiting detailed description of example embodiments, with reference to the appended drawings.

FIG. 1 shows a schematic diagram of an integrated optical structure, according to example embodiments.

FIG. 2 shows a schematic diagram of an integrated optical structure, according to example embodiments.

FIG. 3 shows a schematic diagram of an integrated optical structure, according to example embodiments.

FIG. 4 shows a schematic diagram of an integrated optical structure, according to example embodiments.

FIG. 5 shows a schematic diagram of an integrated optical structure, according to example embodiments.

FIG. 6 shows a schematic diagram of an integrated optical structure, according to example embodiments.

FIG. 7 shows a schematic diagram of an integrated optical structure, according to example embodiments.

FIG. 8A shows a perspective view of an integrated optical structure, according to example embodiments.

FIG. 8B shows a simulation of a displacement of a beam structure, according to example embodiments.

FIG. 9 shows simulation results of optical phase shifts and optical losses in exemplary integrated optical structures, according to example embodiments.

FIG. 10 shows a schematic diagram of an optical communication device, according to example embodiments.

FIG. 11 shows steps of a method for fabricating an integrated optical structure, according to example embodiments.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

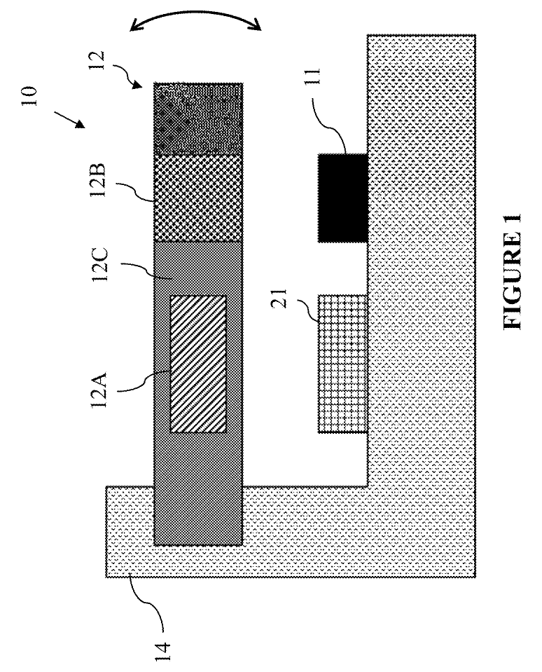

FIG. 1 shows a schematic diagram of an integrated optical structure 10, according to example embodiments.

The integrated optical structure 10 may include an optical waveguide structure 11. The integrated optical structure 10 also may include a beam structure 12, which is suspended at a first distance to the optical waveguide structure 11. The beam structure 12 may include a first section 12A of a first material and a second section 12B of a second material. The first material may be a conductive material, and the second material may be a non-conductive material or a semiconductor. The integrated optical structure 10 may further include an electrode structure 21 arranged at a second distance to the beam structure 12. The integrated optical structure 10 may include an electrical contact structure configured to apply a voltage between the electrode structure 21 and the first section 12A of the beam structure 12, which may thereby induce an electrostatic force acting between the electrode structure 21 and the first section 12A. The beam structure 12 may be designed to be elastically bent towards or away from the optical waveguide structure 11 by the electrostatic force causing a change in an optical property (e.g., a phase) of an optical signal propagating through the optical waveguide structure 11.

FIG. 1 shows a cross-sectional view along a plane, which is perpendicular to a direction in which the optical waveguide structure 11 runs, e.g., perpendicular to the direction in which the optical signal is guided by the waveguide structure 11.

The integrated optical structure 10 may form an optical modulator, e.g., a phase tuner or phase shifter. The phase tuner may be a nano-electro-opto-mechanical (NOEM) phase tuner. The optical waveguide structure 11 may be connected to or be a component of an optical interconnect, e.g., in an integrated circuit.

The integrated optical structure 10 may use less power and may offer faster modulation speeds than other thermo-optic phase tuners. The integrated optical structure 10 may use zero or very low static power and may offer MHz to sub-GHz speeds for “switching” the optical property. Other thermo-optic phase tuners may operate at speeds of a few kHz to MHz and may have a high power consumption, e.g., of several mW.

The optical waveguide structure 11 may be made of silicon and surrounded by low refractive index material(s).

The optical waveguide structure 11 may include or may form an optical waveguide. The optical signal may propagate through the optical waveguide.

The beam structure 12 may form an actuating element. The beam structure 12 may be arranged in parallel to a surface of the optical waveguide structure 11. The beam structure 12 may be suspended at the first distance above the optical waveguide structure 11.

The beam structure 12 may be suspended on one end as shown in FIG. 1. Thereby, the first section 12A may be arranged towards the suspended end and the second section 12B may be arranged towards a free end of the beam structure 12. Thus, the beam structure 12 may be a cantilever, which may bend towards and/or away from the waveguide structure 11, as indicated by the arrow in FIG. 1.

Alternatively, the beam structure may be suspended on two opposite ends. In this case, the second section 12B of the beam structure may be arranged away from the two suspended ends, e.g., towards the center between the two opposite suspended ends of the beam structure 12.

The optical signal may be an electromagnetic wave, which propagates through the waveguide structure 11. Thereby, a portion of the energy density of the electromagnetic wave may be located outside of the waveguide structure 11 and may be thus influenced by the surrounding of the waveguide structure 11. The reduction or increase of the distance between the waveguide structure 11 and the beam structure 12, e.g., the second section 12B of the beam structure, may change the immediate surrounding of the waveguide structure 11 and may affect the optical properties (e.g., the phase) of the optical signal.

When the voltage is applied, the beam structure 12 may be bent towards or away from the waveguide structure 11 by the electrostatic force. The resulting reduction or increase of the distance between the waveguide structure 11 and the beam structure 12, e.g., the second section 12B of the beam structure, may change an effective refractive index (n_{eff}) (e.g., a mode index) as experienced by (at least a part of) the optical signal propagating through the waveguide structure 11. This may in turn cause the change in the optical parameter (e.g., phase) of the optical signal. Thereby, the change of n_{eff} (also referred to as: Δn_{eff}) as experienced by the optical signal can be stronger than in other p-n junction based phase tuners. The Δn_{eff} in the integrated optical structure 10 may be between 10⁻³ and 10⁻¹.

When the voltage is switched off, the beam structure 12 may return to a straight (i.e., non-bent) orientation. A distinction can therefore be made between two switching states of the integrated optical structure 10, wherein each switching state may be associated with a different n_{eff}.

The second section 12B of the beam structure may be arranged directly above or below the optical waveguide structure 11 when the beam structure is not bent.

The first section 12A of the beam structure may be placed close to the electrode structure 21. “Close” may mean that the first section 12A (and thus the beam 12) is displaced by the electrostatic forces when two different voltages are applied to 12A and 21. The second section 12B of the beam structure 12 may be placed close to the waveguide structure 11. “Close” may mean that the effective refractive index of the light propagating in the waveguide structure 11 may change when the second section 12B is displaced together with the beam 12 (or parts thereof).

The first material of the first section 12A may be a metal or doped semiconductor, e.g., doped silicon. The first section 12A may form a counter electrode to the electrode structure 21.

The second material of the second section 12B may be a low-loss optical material. The second material may be a silicon oxide or silicon nitride. Since the second section 12B may be closest to the waveguide structure 11 and its movement may be responsible for the change of the effective reflective index (and thus phase modulation), designing this section from a low-loss optical material may reduce optical losses in the integrated optical structure 10.

The beam structure 12 may comprise a base structure 12C. The first section 12A and/or the second section 12B may be embedded in the base structure 12C. The base structure 12C may be a membrane.

The base structure 12C (or membrane) may be made of the same material as the second section 12B of the beam structure 12, e.g., a low-loss optical material, such as silicon oxide.

The integrated optical structure 10 may further include a supporting structure 14. The beam structure 12, e.g., the base structure 12C of the beam structure 12, may be anchored to the supporting structure on one end. The supporting structure 14 may be a part of an encapsulation structure that surrounds the beam structure on at least three sides.

The optical waveguide structure 11 and the electrode structure 21 may be arranged on the supporting structure 14, as shown in FIG. 1. The electrode structure 21 may be formed by a conductive pad.

At least a part of the beam structure 12 may be movable relative to the supporting structure 14. The first section 12A and second section 12B of the beam structure 12 may be arranged in the movable region and may be mechanically connected via the base structure 12C (e.g., membrane) so that the moving of one of them will cause the movement of the other one.

The beam structure 12 may be designed to have an elastic modulus that facilitates bending by the electrostatic force by such a degree that a tangible change of the optical property of the optical signal occurs.

The electrical contact structure (not shown in FIG. 1) may include a number of (vertical) electrical lines, which may be electrically connected to the electrode structure 21 and the first section 12A of the beam structure 12. The electrical lines may be formed from a metal, such as tungsten or copper. The electrical contact structure may further be connected to a voltage source for generating the voltage, e.g., via electrical contact pads. The voltage source may be an external voltage source or may be a component of the optical structure. The electrical contact structure may apply a bias voltage (V_{Bias}) to the electrode structure 21 and may connect the first section 12A to ground (GND), or vice versa.

The optical waveguide structure 11 may be not in physical contact with the electrode structure 21. This may further reduce optical losses in the waveguide structure 11.

The first distance between the optical waveguide structure 11 and the beam structure 12 may be less than 300 nm, e.g., less than 200 nm. This distance may refer to the minimal distance between optical waveguide structure 11 and the beam structure 12 when no voltage (V_{Bias}) is applied and thus if the beam structure 12 is not bent towards or away from the waveguide structure 11. When applying the voltage, the structure 12 may be bent towards or away from the waveguide structure 11, reducing or increasing this distance, respectively. The second distance may be identical to the first distance or deviate from the first distance by only a few nanometers, e.g., when the waveguide structure 11 and the electrode structure 21 are formed in the same plane of the integrated optical structure 10.

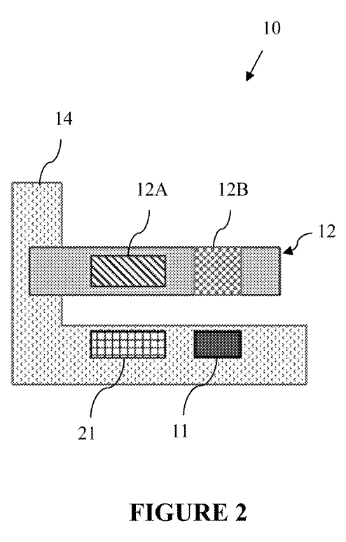

FIG. 2 shows a schematic diagram of an integrated optical structure 10, according to example embodiments. FIG. 2 shows a cross-sectional view of the integrated optical structure 10.

In FIG. 2, the waveguide structure 11 and the electrode structure 21 are embedded in the supporting structure 14.

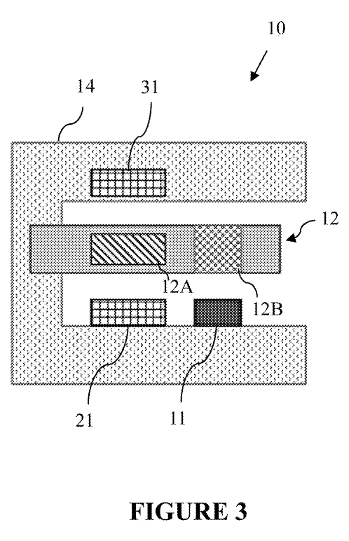

FIG. 3 shows a schematic diagram of an integrated optical structure 10, according to example embodiments. FIG. 3 shows a cross-sectional view of the integrated optical structure 10.

FIG. 3 depicts a further electrode structure 31 arranged at a third distance to the beam structure on a side which is opposite to the electrode structure 21. The third distance may be identical to the second distance and/or may deviate from the second distance by a few nanometers.

The electrical contact structure may be configured to apply a further voltage between the further electrode structure 31 and the first section 12A of the beam structure 12 inducing a further electrostatic force acting between the further electrode and the first section 12A. The beam structure 12 may be designed to be elastically bent towards or away from the further electrode 31 structure by the further electrostatic force.

The beam structure 12 may be switched between a first state in which it may bend towards the electrode structure 21 and a second state in which it may bend away from the electrode structure 21 and towards the further electrode structure 31, or vice versa. In this way, a difference in n_{eff} (and potentially in the optical property) may be enhanced between both states.

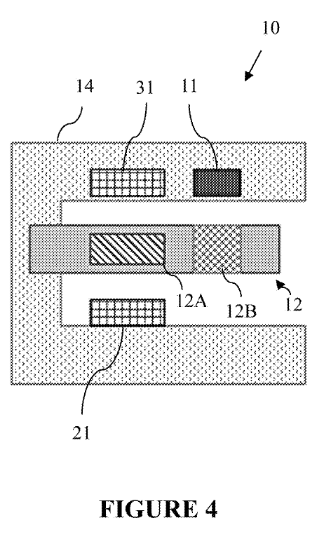

FIG. 4 shows a schematic diagram of an integrated optical structure 10, according to example embodiments. FIG. 4 shows a cross-sectional view of the integrated optical structure 10.

In the exemplary embodiment shown in FIG. 4, the waveguide structure 11 and the electrode structure 21 may be arranged on opposite sides of the beam structure 12. In this example, the optical structure 10 may include the further electrode structure 31, which may be on the same side of the beam structure 12 than the waveguide structure.

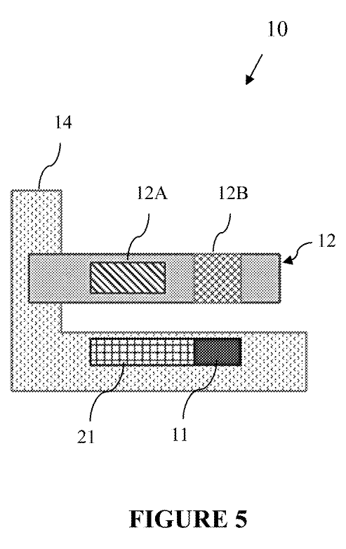

FIG. 5 shows a schematic diagram of an integrated optical structure 10, according to example embodiments. FIG. 5 shows a cross-sectional view of the integrated optical structure 10.

As depicted in FIG. 5, the electrode structure 21 and the waveguide structure 11 may be in direct physical contact with each other.

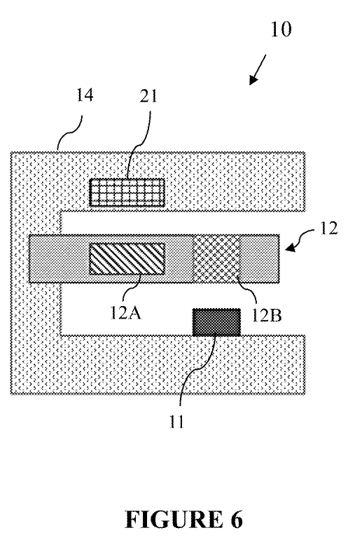

FIG. 6 shows a schematic diagram of an integrated optical structure 10, according to example embodiments. FIG. 6 shows a cross-sectional view of the integrated optical structure 10.

As shown in FIG. 6, the electrode structure 21 and the waveguide structure may be arranged on opposite sides of the beam structure 12.

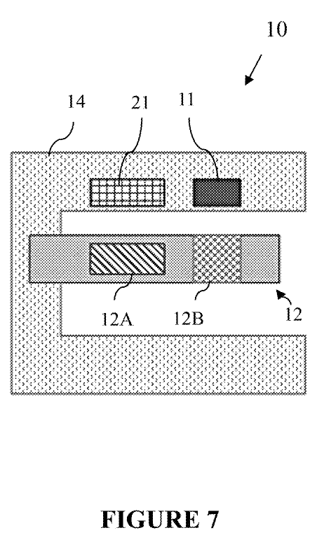

FIG. 7 shows a schematic diagram of an integrated optical structure 10, according to example embodiments. FIG. 7 shows a cross-sectional view of the integrated optical structure 10.

As depicted in FIG. 7, both the electrode structure 21 and the waveguide structure 11 may be arranged on an upper side of the beam structure 12. Upper and lower may be relative terms, as the integrated optical structure 10 may be arranged in different orientations and rotations, or installed in various ways.

The optical waveguide 11 may be used to propagate light, while the light phase may be tuned by applying a voltage difference between the first section 12A and the electrode structures 21 and/or 31. The optical structure 10 may have a low-power consumption, because its design may only consume power when the beam structure 12 is moving, and no power consumption after the beam structure 12 is in the desired position. Furthermore, the optical structure 10 may exhibit low optical losses, because the second section 12B, which may facilitate a phase change, may be constructed from low-loss optical materials.

The optical waveguide structure 11 may include a p-n-junction. The p-n-junction may be formed by an interface of a n-type semiconductor material and a p-type semiconductor material (e.g., n-doped silicon and p-doped silicon). A part of the waveguide structure 11 may be formed from the n-type material and a part of the waveguide structure 11 may be formed from the p-type material. A vertical p-n-junction may be formed at an interface of these materials. The n-type doped material and the p-type doped material may be connected to respective electrical lines of the electrical contact structure. The electrical contact structure may be configured to apply a control voltage to the p-n-junction, which may cause an additional change in the optical property of the optical signal propagating through the waveguide structure. The control voltage may be a pulsed and/or alternating current (AC)-type voltage with a frequency greater than 10 GHz.

Doing so may facilitate combining the advantages of the optical modulation by the bending beam structure 12 and by the p-n-junction in a single, integrated structure 10. The p-n-junction may have fast modulation speeds (e.g., tens of GHz) with weaker phase tuning (e.g., Δn_{eff} of around 10⁻⁴), while the bending beam structure 12 may offer moderate modulation speeds (e.g., 1 MHz to sub-GHz) with higher phase changes (e.g., Δn_{eff} between 10⁻³ and 10⁻¹). Furthermore, these modulation techniques may involve little power compared to other thermo-optic modulators.

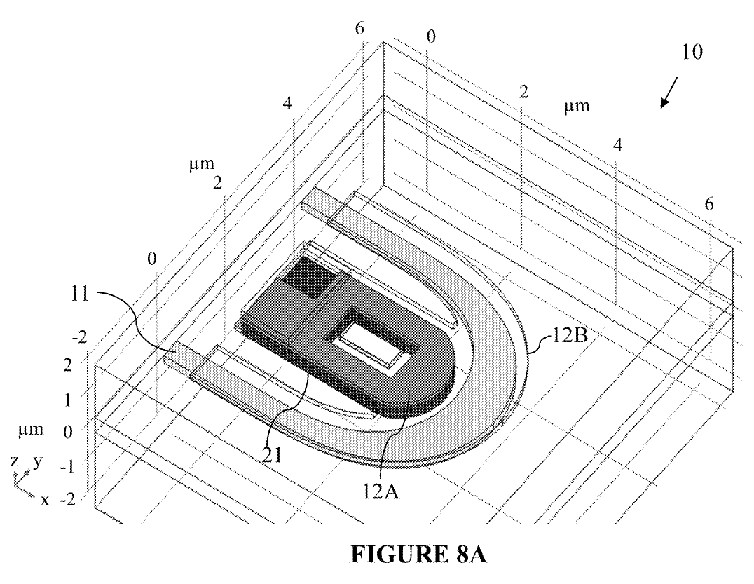

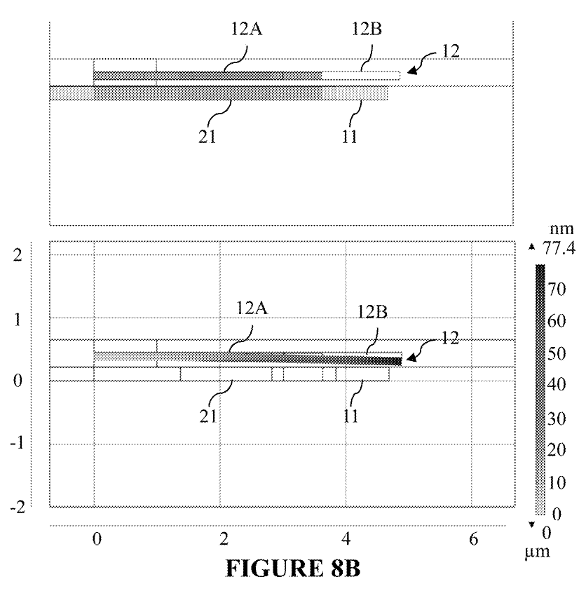

FIG. 8A shows a perspective view of an integrated optical structure 10, according to example embodiments. FIG. 8A shows a perspective view of the integrated optical structure 10.

The waveguide structure 11 may run in a semicircle around the electrode structure 21. The beam structure may be a disk-shaped structure above the waveguide structure 11. The first section 12A may be arranged above the electrode structure 21. The second section 12B (which is transparent in FIG. 8A) may be arranged above the waveguide structure 11.

Alternatively, the optical waveguide structure 11 could also be arranged in a closed loop forming a ring waveguide. The integrated optical structure may further include at least one waveguide which may be arranged to pass by the ring waveguide. Thereby, light with a wavelength that corresponds to a resonance wavelength of the ring waveguide may be coupled from the waveguide into the ring waveguide, or vice versa.

In FIG. 8A, the base material of the beam structure 12 may be formed by silicon oxide that may be also used for the supporting structure. The first section 12A of the beam structure 12 may be formed by doped polycrystalline silicon. The second section 12B may be formed by silicon oxide. The electrode structure 21 may be formed by doped crystalline silicon. The waveguide structure 11 may be formed by intrinsic crystalline silicon.

In the optical structure 10 shown in FIG. 8A, the beam structure 12 may bend when a voltage difference is applied between the first section 12A and the electrode structure 21. The bending of the beam structure 12 may bring the second section 12B closer to the waveguide structure 12, which may result in optical phase shift.

FIG. 8B shows a simulation of a displacement of a beam structure 12, according to example embodiments. The two portions of FIG. 8B show a side-view of the integrated optical structure 10.

In the top/upper portion of FIG. 8B, no voltage is applied between the first section 12A and the electrode structure 21, such that the beam structure 12 is not displaced. In the bottom/lower portion of FIG. 8B, a driving voltage of 17.89 volts (V) is applied between the first section 12A and the electrode structure 21, causing a displacement of the beam structure 12.

In these simulations, the thickness of the electrode structure 21 and the waveguide structure 11 was 210 nm, the silicon oxide thickness above the structures 11 and 12 was 10 nm, the air gap between the waveguide structure 11 and the beam structure 12 was 100 nm, the thickness of the beam structure 12 was 130 nm, and the thickness of the first section 12A was 100 nm with 15 nm distance to the bottom of the beam structure 12.

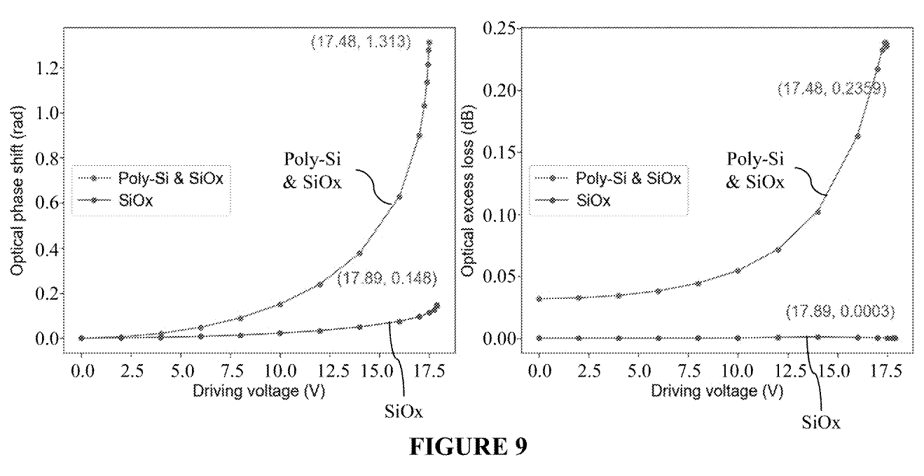

FIG. 9 shows simulation results of optical phase shifts and optical losses in exemplary integrated optical structures, according to example embodiments. The optical phase shifting and the excess loss was simulated under different driving voltages for two different structures.

The simulations were carried out with the following integrated optical structures: one structure having a beam structure with a second section 12B made from silicon oxide (SiOₓ), i.e., a low loss optical material (referred to as “SiOx” in FIG. 9) and a reference optical structure in which the second section 12B is made from intrinsic poly-Si, i.e., a “high loss” optical material (referred to as “Poly-Si & SiOx” in FIG. 9).

The simulation results show that the usage of poly-Si for the second section 12B (i.e., for the part of the beam that is closest to the waveguide) may lead to a strong phase shift, but may also cause strong optical excess losses, e.g., at high voltages. The use of a low-loss optical material, such as silicon oxide, for the second section 12B may reduce the optical excess losses and facilitate an optical phase shift at certain voltages.

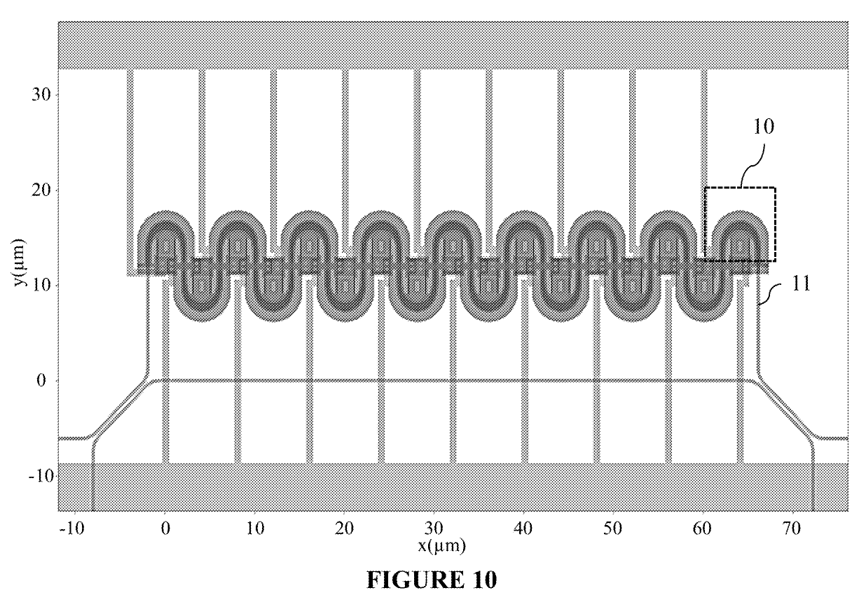

FIG. 10 shows a schematic diagram of an optical communication device, according to example embodiments. The optical communication devices may include a plurality of the integrated optical structures 10.

The optical communication device shown in FIG. 10 may be a Mach-Zehnder interferometer with integrated optical structures 10 that are arranged in a cascaded manner. Based on the number of cascades, phase shifts of varying degrees may be achieved.

Besides the Mach-Zehnder interferometer, the integrated optical structure 10 may also be integrated in a ring resonator, a ring modulator or a micro ring-disk modulator.

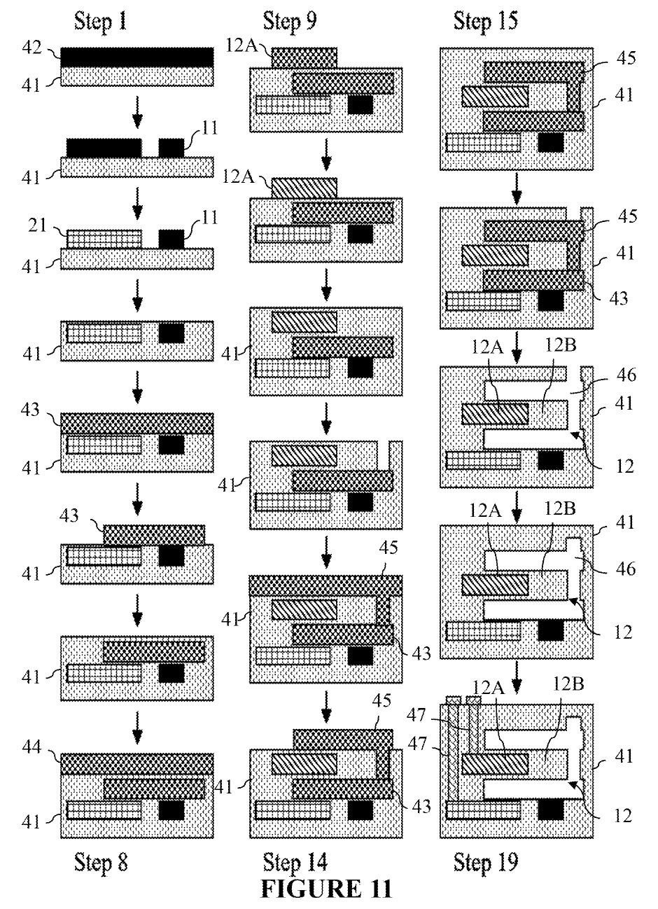

FIG. 11 shows steps of a method for fabricating an integrated optical structure 10, according to example embodiments.

The method includes the formation of the optical waveguide structure 11 and the electrode structure 21. These structures may be formed by providing an insulator substrate, e.g., a silicon oxide substrate 41, with a silicon layer 42 on top, and subsequently patterning the silicon layer 42 (steps 1 and 2 in FIG. 11). The insulator substrate with the silicon layer can be provided in the form of a silicon-on-insulator (SOI) wafer. There may be one or more extra material layers arranged under the insulator, e.g., silicon, as the substrate.

A first section of the patterned silicon layer 42 may form the waveguide structure 11 and a second section may form the electrode structure 21. The section forming the electrode structure 21 may be doped in subsequent step 3 to make it conductive.

The method may further include the formation of the beam structure which may be suspended at a first distance to the optical waveguide structure 11, and which may include the first section 12A of the first material and the second section 12B of the second material. The first material may be a conductive material and the second material may be a non-conductive material or a semiconductor.

Steps 4 to 18 in FIG. 11 show an exemplary process flow for forming such a beam structure above the electrode structure 21 and the waveguide structure 11.

A further silicon oxide layer 41 may be deposited to protect the waveguide and electrode structures 11, 21 (step 4). Then, a sacrificial layer 43 may be deposited on top of the silicon oxide layer 41 (step 5). This sacrificial layer 43 may form a bottom sacrificial layer and may be made of polycrystalline silicon. Subsequently, this bottom sacrificial layer 43 may be patterned and a further silicon oxide layer 41 can be deposited to protect the bottom sacrificial layer (steps 6 and 7).

Subsequently, a further material layer 44 may be deposited. This layer 44 may be a polycrystalline silicon or a metal layer, e.g., a Cu, Al layer, and can be subsequently structured to form the first section 12A of the beam structure (steps 8 and 9). If layer 44 is a polycrystalline layer it may be doped, as shown in step 10, to make it conductive. This step can be skipped when a metal is deposited in step 8.

In a subsequent step, a further silicon oxide layer 41 may be deposited to protect the first section 12A (step 11). Then, the silicon oxide layer 41 may be opened in a top section to expose the bottom sacrificial layer 43 (step 12). Subsequently, a further polycrystalline silicon may be deposited in and above the generated opening to form a top sacrificial layer 45 that may be connected with the bottom sacrificial layer 43 (step 13). Subsequently, the top sacrificial layer 45 may be patterned and a further silicon oxide layer 41 may be deposited to protect the top sacrificial layer 45 (steps 14 and 15). The oxide layer(s) 41 may form an encapsulation structure around the optical waveguide structure 11, the beam structure 12 and the sacrificial layers 43, 45.

The top and bottom sacrificial layers 43, 45 may form a sacrificial structure around a section of the beam structure 12, which may be exposed in a later step. A part of the sacrificial structure, i.e., the bottom sacrificial layer 43, may be thereby arranged between the beam structure 12 and the optical waveguide structure 11. The sacrificial structure may be arranged such that the beam structure 12, when exposed, is arranged in a parallel orientation to the optical waveguide structure 11.

In step 16, the silicon oxide 41 may be opened to expose the top sacrificial layer 45. Then, the sacrificial structure (e.g., the top and bottom sacrificial layer 45, 43) may be removed, e.g. via an etching (step 17), to expose the beam structure 12. Removing the sacrificial structure may form a cavity 46. The beam structure 12 may be suspended in the cavity 46 on one end. No protective liner layer may be deposited around the beam structure 12, which may simplify the fabrication process.

In step 18, a further silicon oxide layer 41 may be deposited to seal the cavity. In FIG. 11, the second section 12B of the beam structure 12 may be formed from the silicon oxide material at the free end of the beam structure 12.

The method may also include forming an electrical contact structure 47. The electrical contact structure 47 may be formed by processing metallic connection wires or lines, e.g., from tungsten or copper. These wires or lines may be used for delivering the driving voltage to the first section 12A and electrode structure 21. The connection wires or lines may be formed as metal-filled vias in the silicon oxide layer(s) 41.

During operation of the thus fabricated integrated optical structure, the electrical contact structure 47 may be configured to apply a voltage between the electrode structure 21 and the first section 12A of the beam structure inducing the electrostatic force acting between these two elements. The beam structure 12 may be designed to be elastically bent towards or away from the optical waveguide structure 11 by the electrostatic force causing the change in an optical property of the optical signal propagating through the optical waveguide structure 11.

While some embodiments have been illustrated and described in detail in the appended drawings and the foregoing description, such illustration and description are to be considered illustrative and not restrictive. Other variations to the disclosed embodiments can be understood and effected in practicing the claims, from a study of the drawings, the disclosure, and the appended claims. The mere fact that certain measures or features are recited in mutually different dependent claims does not indicate that a combination of these measures or features cannot be used. Any reference signs in the claims should not be construed as limiting the scope.

What is claimed is:

1. An integrated optical structure, comprising:
an optical waveguide structure;
a beam structure, wherein the beam structure is suspended at a first distance to the optical waveguide structure, wherein the beam structure comprises a first section of a first material and a second section of a second material, and wherein the first material is a conductive material and the second material is a non-conductive material or a semiconductor;
an electrode structure arranged at a second distance to the beam structure; and
an electrical contact structure configured to apply a voltage between the electrode structure and the first section of the beam structure and induce an electrostatic force acting between the electrode structure and the first section, wherein the beam structure is designed to be elastically bent towards or away from the optical waveguide structure by the electrostatic force causing a change in an optical property of an optical signal propagating through the optical waveguide structure.

2. The integrated optical structure of claim 1, wherein the optical property comprises a phase.

3. The integrated optical structure of claim 1, wherein the optical waveguide structure is not in physical contact with the electrode structure.

4. The integrated optical structure of claim 1, wherein the beam structure is suspended on a first end, and wherein the first section is arranged towards the first end.

5. The integrated optical structure of claim 4, wherein the second section is arranged towards a second end of the beam structure.

6. The integrated optical structure of claim 1, wherein the second section is arranged directly above or below the optical waveguide structure when the beam structure is not bent.

7. The integrated optical structure of claim 1, wherein the first material is a metal or doped semiconductor.

8. The integrated optical structure of claim 7, wherein the first material is doped silicon.

9. The integrated optical structure of claim 1, wherein the second material is silicon oxide or silicon nitride.

10. The integrated optical structure of claim 1, wherein the beam structure comprises a base structure, wherein the first section is embedded in the base structure, and wherein the second section is embedded in the base structure.

11. The integrated optical structure of claim 10, wherein the second section comprises a material, and wherein the base structure comprises the material.

12. The integrated optical structure of claim 1, further comprising:
a supporting structure, wherein the beam structure is anchored to the supporting structure, and wherein the optical waveguide structure is in or on the supporting structure.

13. The integrated optical structure of claim 12, wherein the electrode structure is in or on the supporting structure.

14. The integrated optical structure of claim 1, wherein the electrode structure is on a same side of the beam structure as the optical waveguide structure.

15. The integrated optical structure of claim 1, wherein the electrode structure and the optical waveguide structure are on opposite sides of the beam structure.

16. The integrated optical structure of claim 1, further comprising:
a further electrode structure at a third distance to the beam structure on a side opposite to the electrode structure.

17. The integrated optical structure of claim 16, wherein the electrical contact structure is configured to apply a further voltage between the further electrode structure and the first section of the beam structure inducing a further electrostatic force acting between the further electrode structure and the first section, wherein the beam structure is designed to be elastically bent towards or away from the further electrode structure by the further electrostatic force.

18. An optical communication device comprising:
an integrated optical structure comprising:
an optical waveguide structure;
a beam structure, wherein the beam structure is suspended at a first distance to the optical waveguide structure, wherein the beam structure comprises a first section of a first material and a second section of a second material, and wherein the first material is a conductive material and the second material is a non-conductive material or a semiconductor;
an electrode structure arranged at a second distance to the beam structure; and
an electrical contact structure configured to apply a voltage between the electrode structure and the first section of the beam structure and induce an electrostatic force acting between the electrode structure and the first section, wherein the beam structure is designed to be elastically bent towards or away from the optical waveguide structure by the electrostatic force causing a change in an optical property of an optical signal propagating through the optical waveguide structure.

19. The optical communication device of claim 18, wherein the optical communication device is a Mach-Zehnder interferometer, an optical resonator, or a ring resonator.

20. A method, comprising:
forming an optical waveguide structure;
forming a beam structure suspended at a first distance to the optical waveguide structure, wherein the beam structure comprises a first section of a first material and a second section of a second material, wherein the first material is a conductive material and the second material is a non-conductive material or a semiconductor;
forming an electrode structure arranged at a second distance to the beam structure; and
forming an electrical contact structure configured to apply a voltage between the electrode structure and the first section of the beam structure inducing an electrostatic force acting between the electrode structure and the first section, wherein the beam structure is designed to be elastically bent towards or away from the optical waveguide structure by the electrostatic force causing a change in an optical property of an optical signal propagating through the optical waveguide structure.
